(19) United States
(12) Patent Application Publication
(10) Pub. No.: US 2002/0030393 A1
(43) Pub. Date: Mar. 14, 2002

(54) Child seat anchor connector

(76) Inventor: John Alexander Galbreath, Reisterstown, MD (US)

Correspondence Address: JOHN ALEXANDER GALBREATH, 2516 CHESTNUT WOODS CT, REISTERSTOWN, MD, 21136, US

(21) Appl. No.: 09/950,402

(22) Filed: Sep. 11, 2001

Related U.S. Application Data
(60) Provisional application No. 60/231,593, filed on Sep. 11, 2000.

(51) Int. Cl. B60N 2/28

(52) U.S. Cl. 297/250.1

(57) ABSTRACT

The invention is a device which connects a child safety seat, such as that used in an automobile, to an anchor bar installed in the automobile. The connector includes an anchor end adapted to engage the anchor bar, and a child seat end adapted for connecting to either flexible webbing or a solid connection point on a child safety seat. The anchor end has an inwardly beveled surface which forms a docking guide. The docking guide surrounds a rectangular area in the center of the anchor end, wherein a latch plate is located. In operation, the anchor end of the connector is positioned over and urged toward the anchor bar. The beveled front surface of the latch plate allows the anchor bar to urge the latch plate upward, against the resistance provided by a biasing spring. The connector is further urged onto the anchor bar until the anchor bar passes under the latch plate and into an anchor bar cavity, which retains the anchor bar within the connector. To release the connector from the anchor bar, the user depresses a release button located on the outer surface of the connector.

### CROSS-REFERENCES TO RELATED APPLICATIONS

This non-provisional application claims priority to U.S. Provisional Application No. 60/231,593, filed Sep. 11, 2000, and that previous provisional application is hereby incorporated by reference.

### BACKGROUND OF THE INVENTION

1. Field of the Invention

This invention is in the area of child seat connection systems, specifically a device which connects a child safety seat, such as that used in an automobile, to an anchor bar installed in the automobile.

2. Description of the Related Art

Child safety seats have been previously secured in automobiles by using the seat belts of the automobile—that is, the existing seat belts are threaded in or around the child safety seat and latched in the usual manner, ostensibly securing the safety seat to the automobile seat, and thus to the automobile itself.

Recently, the National Highway Traffic Safety Administration (NHTSA) mandated the use of standard anchor bars, installed in an automobile by the manufacturer, to secure child safety seats to the automobile. Correspondingly, child safety seat manufacturers are now required to provide, on their safety seats, means to engage the anchor bars installed in the automobile.

Using a simple hook connected to webbing attached to the safety seat, as a means to engage the anchor bar, has been contemplated by various child seat manufacturers. However, using a hook as a connector has several key disadvantages. Most important among these disadvantages is that it is difficult for a consumer to engage and disengage the hook from the anchor bar. A hooking and unhooking motion is required, which ordinarily would not be an insurmountable problem; however, the anchor bar is typically buried between the automobile seat cushions, and is not readily visible to a consumer. Thus, it is often difficult to maneuver the hook onto the anchor bar, and to remove it from the anchor bar.

Accordingly, several objects and advantages of my invention are:

It is easy, quick, and intuitive to use—yet safe and secure. A simple push-in or pull-out motion is all that is necessary to engage and disengage the anchor bar—no hooking or unhooking motions are required.

The device provides an “automatic” engagement onto the anchor bar—no buttons need to be pushed. And, it is quick and easy to release—consumers can easily see and reach the release button, because it's not hidden by the seat cushions.

The beveled anchor end of the connector, which guides the connector into place over the anchor bar, makes it easy to connect a child seat to the anchor bar.

It releases under tension more conveniently than a hook fastener—that is, the webbing tension does not have to be released first.

The optional additional lock on the connector's anchor end disables the push-button release, providing an extra measure of security.

The connector can also form the basis for a rigid-link child seat connection system, wherein the child seat is rigidly or semi-rigidly connected to the anchor bar, rather than using webbing at one end of the connector.

Further objects and advantages of my invention will become apparent from a consideration of the drawings and ensuing description.

### SUMMARY OF THE INVENTION

This invention is a device which connects a child safety seat, such as that used in an automobile, to an anchor bar installed in the automobile.

### DESCRIPTION OF THE DRAWINGS

FIG. 1 provides an overall view of the invention, installed on a rear automobile seat.

FIG. 2 illustrates the exterior aspects of the connector, in perspective view.

FIG. 3 shows the connector in cutaway side view, and illustrates the inner latch mechanism which captures and retains the child seat anchor within the connector.

FIG. 4 shows the child seat anchor, the connector, and the webbing attachment in side view, with the connector in position to engage the child seat anchor.

FIG. 5 shows the connector in the process of engaging onto the child seat anchor.

FIG. 6 illustrates the connector in a fully engaged position, wherein the anchor bar of the child seat anchor is retained within the anchor bar cavity in the connector, and the webbing and buckle tongue are engaged with the child seat latch.

FIG. 7 illustrates an alternative embodiment wherein the child seat end of the connector includes a webbing retention pin, surrounded by a webbing loop which is attached to the child safety seat.

FIG. 8 illustrates an alternative embodiment wherein the child seat end of the connector includes a hook retention pin to which a hook, attached to the child safety seat, is connected.

FIGS. 9 and 10 illustrate an alternative embodiment having a swivel lock, operable by a button located on the top surface of the connector.

FIG. 9 shows the swivel lock in an unlocked position, and

FIG. 10 shows the swivel lock in a locked position.

FIG. 11 illustrates an alternative embodiment, wherein the connector does not have an outer casing as in the main embodiment, but rather takes the form of a non-enclosed “clip”.

FIG. 12 illustrates an alternative embodiment, wherein the back (anchor bar-retaining) surface of the latch plate has a substantially non-beveled shape, rather than a beveled shape as in the main embodiment.

### DETAILED DESCRIPTION OF THE INVENTION

The following provides a list of the reference characters used in the drawings:

10. Connector

11a&b. Child seat anchor

12. Automobile seat back

13. Automobile seat cushion

14a&b. Arms

15. Anchor bar

16. Anchor end

17. Child seat end

18. Docking guide

19. Latch plate

20a&b. Anchor arm openings

21. Anchor release button

22. Child seat release button

23. Latch arm

24. Pivot arm

25. Anchor bar cavity

26. Spring

27. Child seat latch

28. Automobile body

29. Webbing

30. Buckle tongue

31. Webbing retention pin

32. Webbing loop

33. Hook retention pin

34. Hook

35. Swivel lock

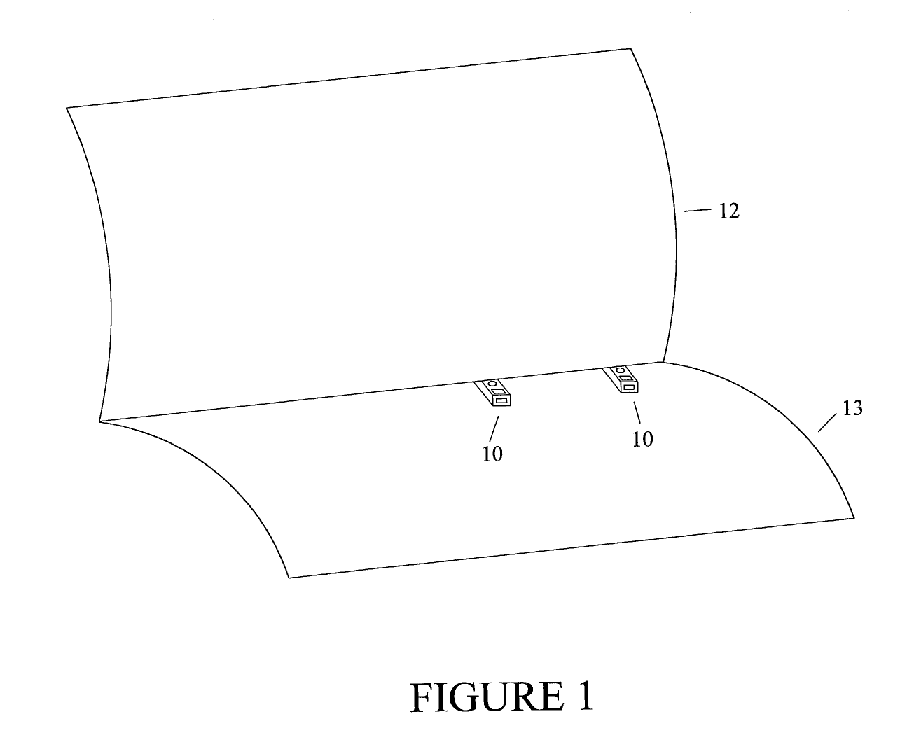

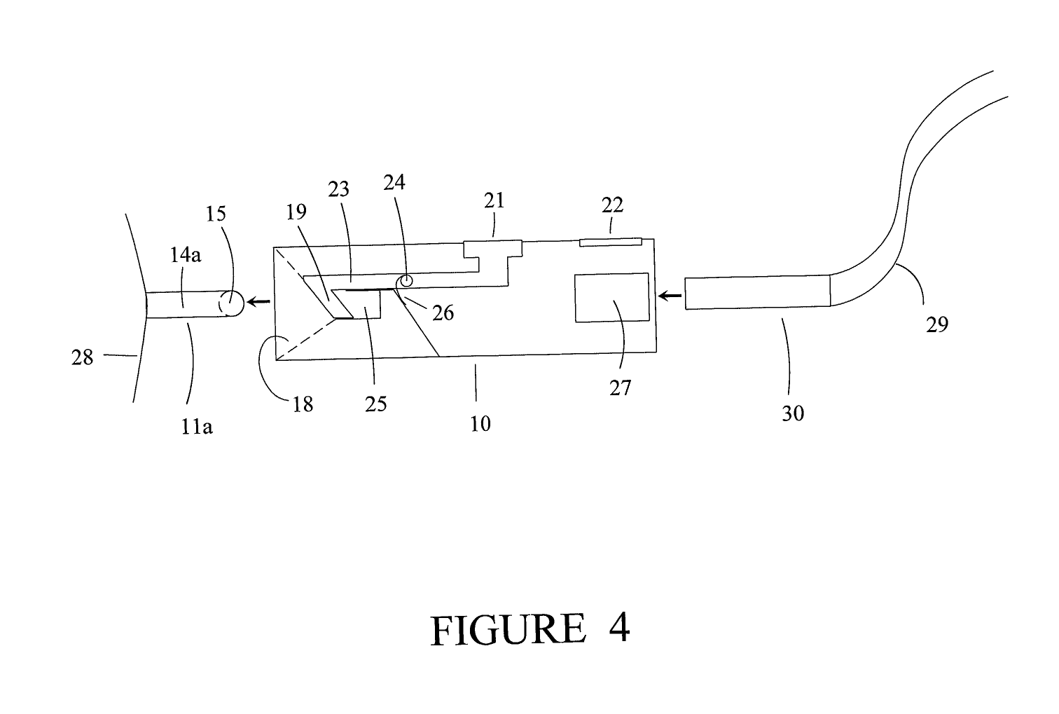

FIG. 1 provides an overall view of the invention, installed on a rear automobile seat. A connector 10 is engaged onto each of two child seat anchors 11a&b (not shown in FIG. 1) attached to the body of the automobile and located at the intersection point of an automobile seat back 12 and an automobile seat cushion 13. Child seat anchors 11a&b, shown in detail in FIGS. 4-6, each comprise two arms 14a&b connected by a cylindrical anchor bar 15 to form an attachment point for a child safety seat, and conform to the National Highway Traffic Safety Administration standard established by 49 CFR Parts 571 and 596 (Uniform Child Restraint Anchorages).

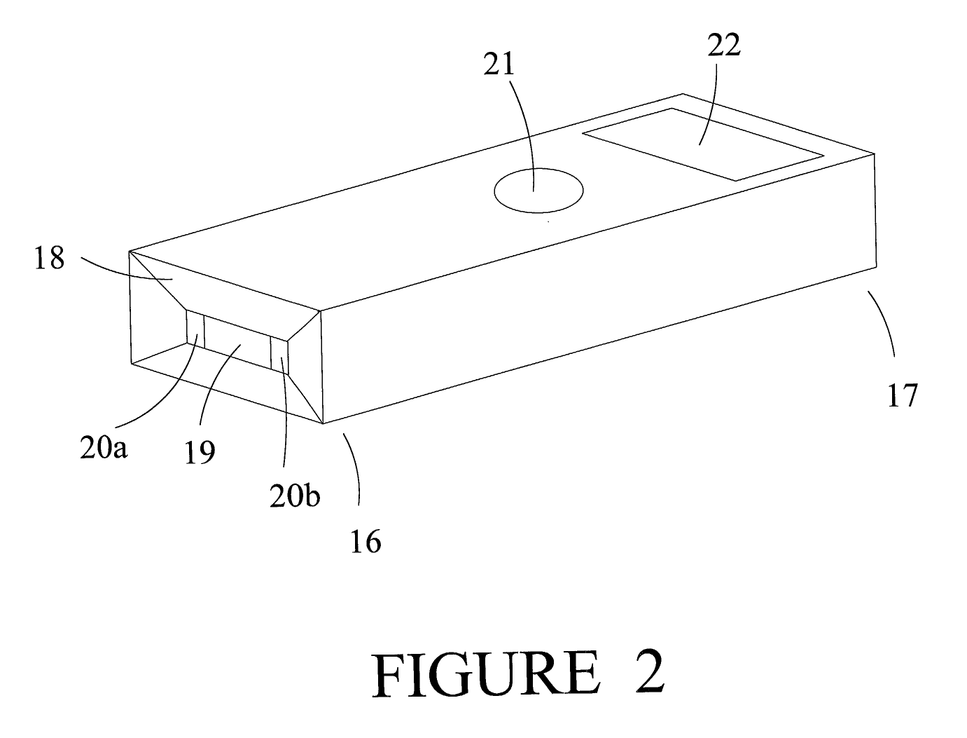

FIG. 2 illustrates the exterior aspects of connector 10, in perspective view. Connector 10 includes an anchor end 16 adapted to engage child seat anchor 11a, and a child seat end 17 adapted for connecting to either flexible webbing or a solid connection point on a child safety seat. Anchor end 16 has an inwardly beveled surface which forms a docking guide 18. Docking guide 18 surrounds a rectangular area in the center of anchor end 16, wherein a latch plate 19 and two anchor arm openings 20a&b are located. Anchor arm openings 20a&b are positioned on opposite sides of latch plate 19. An anchor release button 21, used to disengage connector 10 from child seat anchor 11a, is located on the top exterior surface of connector 10. A child seat release button 22, used to disengage connector 10 from a child safety seat, is also located on the top exterior surface of connector 10.

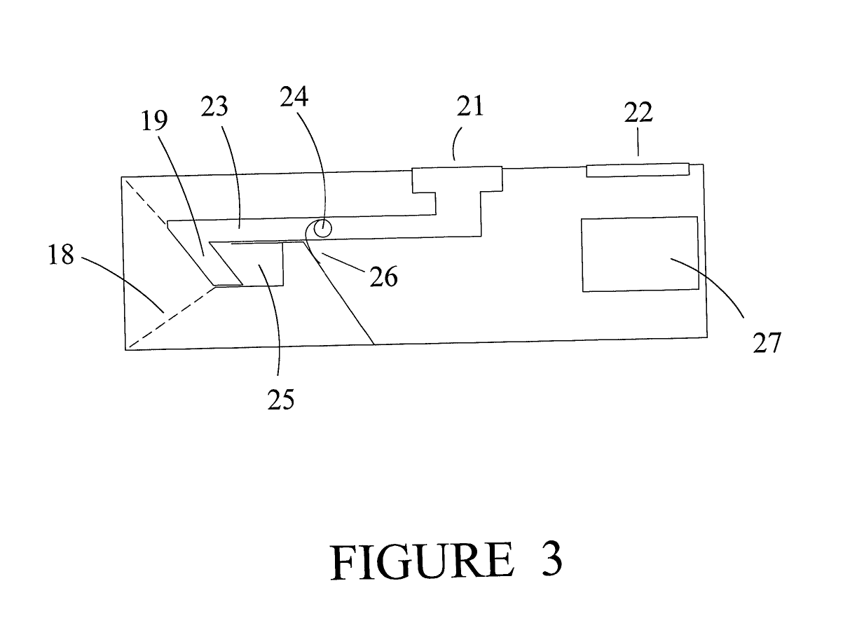

FIG. 3 shows connector 10 in cutaway side view, and illustrates the inner latch mechanism which captures and retains child seat anchor 11a within connector 10. A latch arm 23 connects latch plate 19 and anchor release button 21, and pivots on pivot arm 24. A spring 26 biases latch arm 23, and thus latch plate 19, toward a downward, closed position. Latch plate 19 has a beveled front surface in order to facilitate the passage of the anchor bar 15 portion of child seat anchor 11a into an anchor bar cavity 25. Latch plate 19 also has a beveled back surface, in order to assure positive retention of anchor bar 15 inside anchor bar cavity 25. A child seat latch 27, shown in the figures as a “black box”, is located within child seat end 17. Child seat latch 27 is operable by child seat release button 22, and can take the form of any available seat belt or other-type latch, examples of which are commonly known in the art.

The operation of connector 10 is illustrated in FIGS. 4-6. As shown in FIG. 4, anchor end 16 of connector 10 is positioned over and urged toward child seat anchor 11a, which is attached to an automobile body 28. Before or after this step, a flexible webbing 29 attached to a child safety seat and having a buckle tongue 30 located on its non-child-seat end, is also connected to child seat end 17 of connector 10 via child seat latch 27. It should be noted that in addition to the flexible webbing connection shown in the figures, child seat end 17 can alternatively be connected, via child seat latch 27, to a rigid tongue or other connection point on a child safety seat.

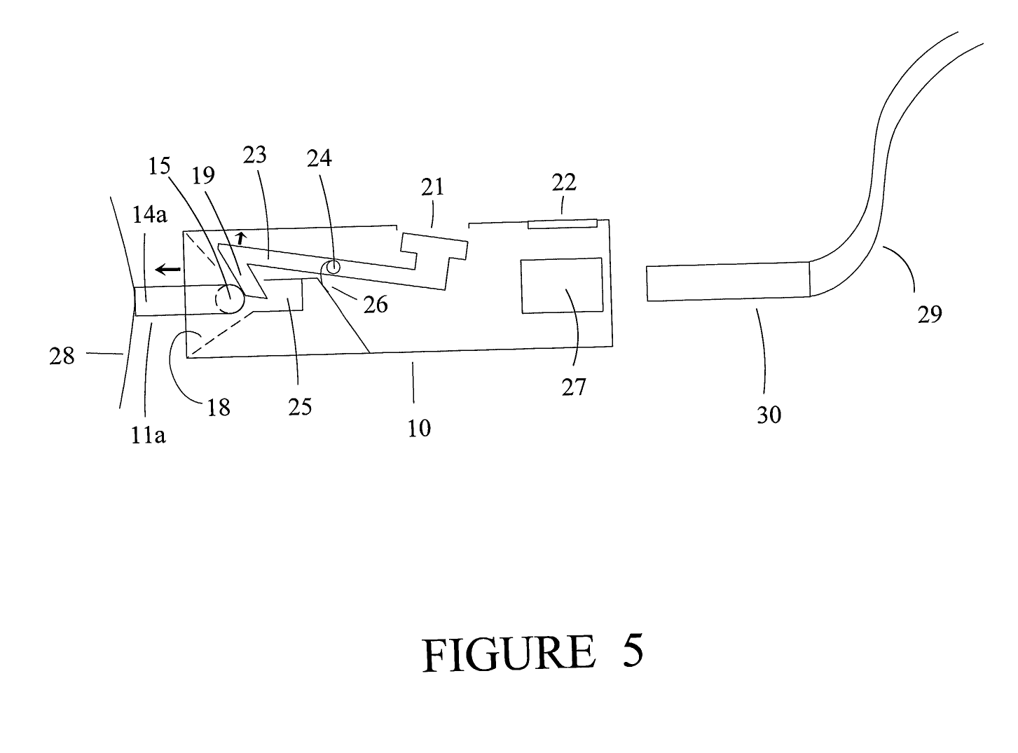

FIG. 5 shows connector 10 in the process of engaging onto child seat anchor 11a. The beveled front surface of latch plate 19 allows anchor bar 15 to urge latch plate 19 upward, against the resistance provided by spring 26. Connector 10 is further urged onto child seat anchor 11a until anchor bar 15 passes under latch plate 19 and into anchor bar cavity 25. After anchor bar 15 has passed completely under latch plate 19, spring 26 biases latch arm 23, and thus latch plate 19, back down into a locked position.

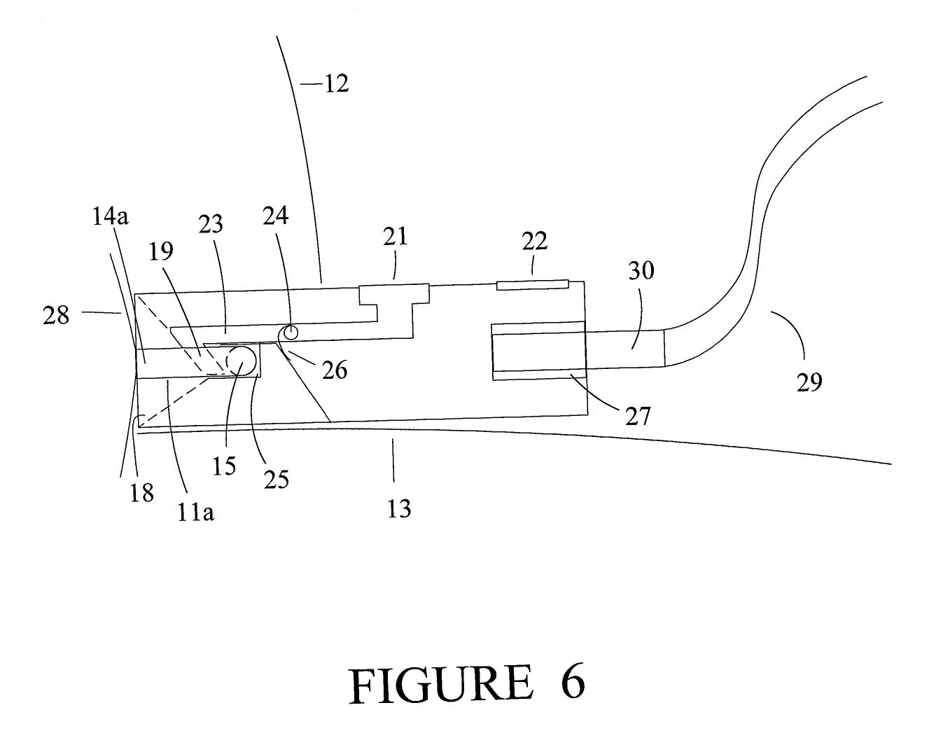

FIG. 6 illustrates connector 10 in a fully engaged position, wherein anchor bar 15 of child seat anchor 11a is retained within anchor bar cavity 25, and webbing 29 and buckle tongue 30 are engaged with child seat latch 27. When connector 10 is in the fully engaged position, anchor bar 15 can only be withdrawn from anchor bar cavity 25 by first depressing anchor release button 21. Similarly, to release connector 10 from webbing 29 and buckle 30, the user depresses child seat release button 22.

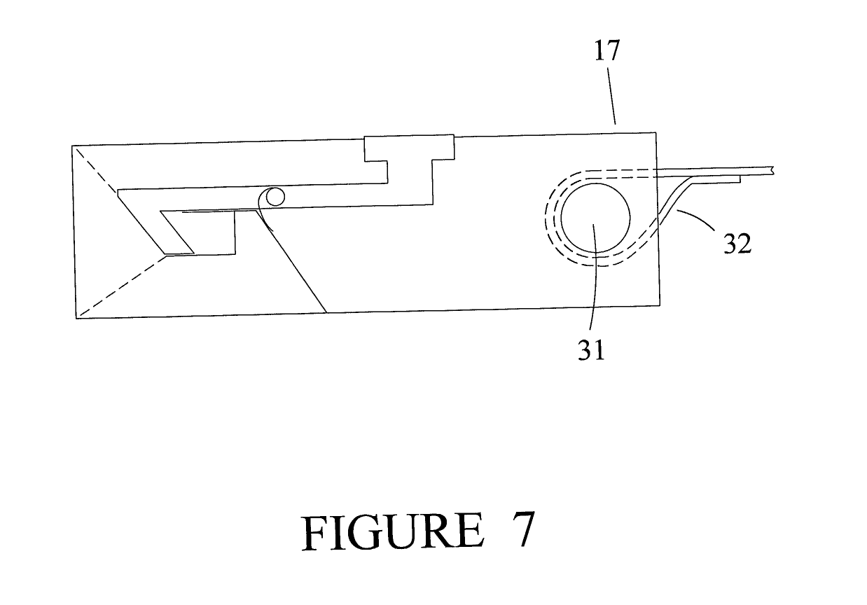

FIG. 7 illustrates an alternative embodiment wherein child seat end 17 includes a webbing retention pin 31, surrounded by a webbing loop 32 which is attached to a child safety seat. Other parts, and other operating steps, are the same as in the main embodiment.

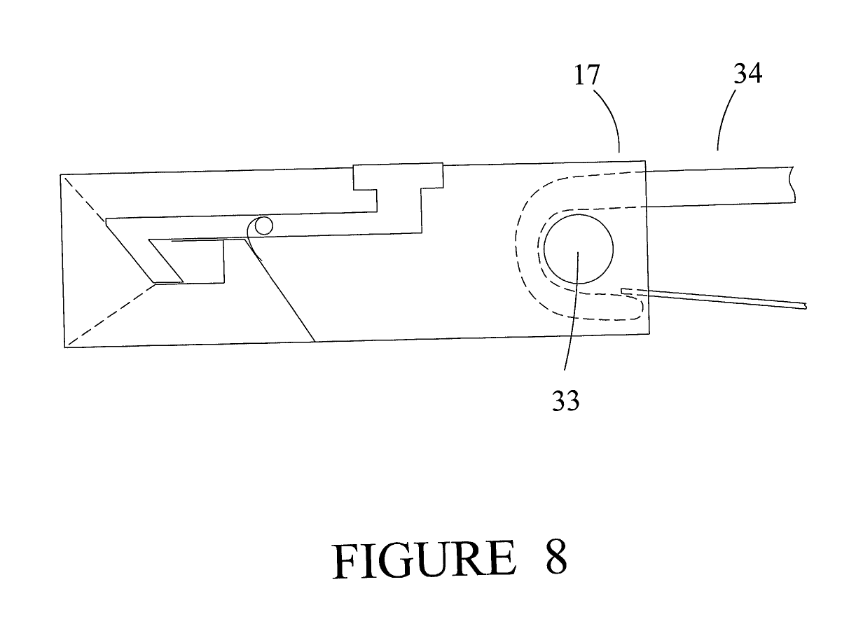

FIG. 8 illustrates an alternative embodiment wherein child seat end 17 includes a hook retention pin 33 to which a hook 34, attached to a child safety seat, can be connected. Other parts, and other operating steps, are the same as in the main embodiment.

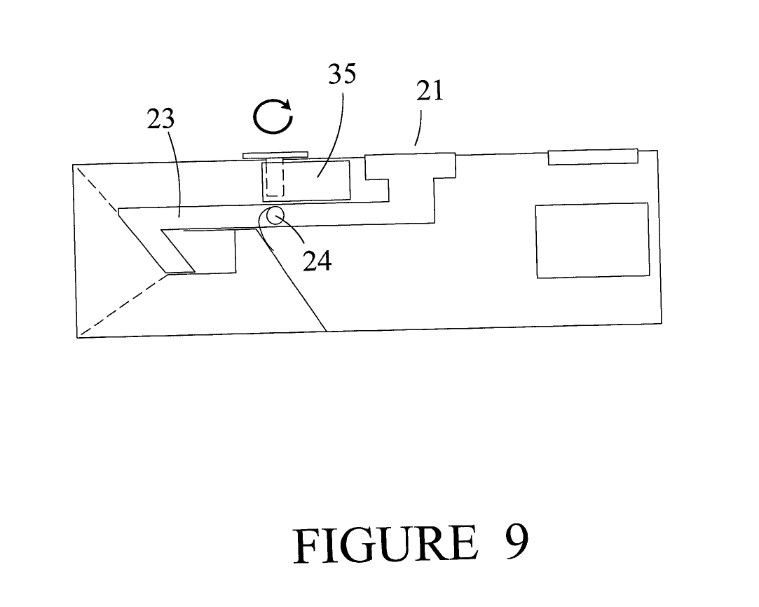

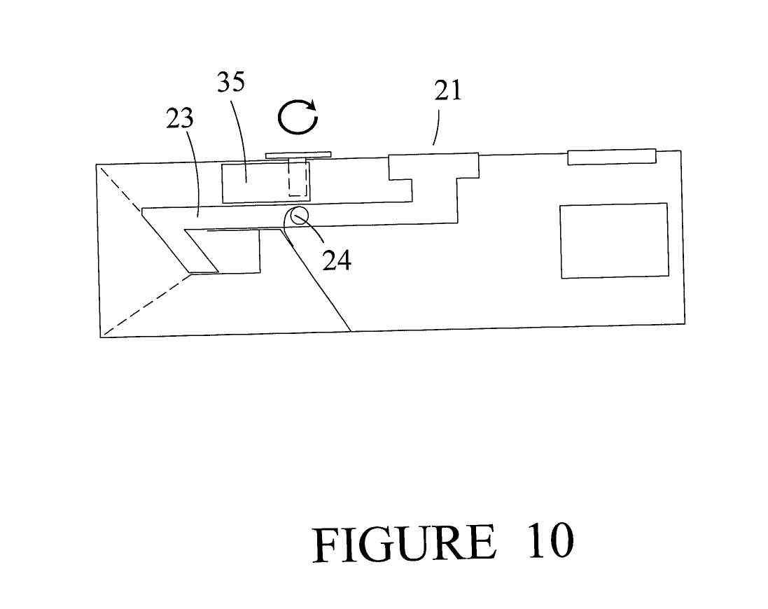

FIGS. 9 and 10 illustrate an alternative embodiment having a swivel lock 35, operable by a button located on the top surface of connector 10. FIG. 9 shows swivel lock 35 in an unlocked position, wherein the operation of anchor release button 21 and thus latch arm 23 is nor blocked, and latch arm 23 is free to pivot about pivot pin 24. FIG. 10 shows swivel lock 35 in a locked position, wherein anchor release button 21 cannot be depressed, and latch arm 23 is blocked from pivoting about pivot arm 24. Other parts, and other operating steps, are the same as in the main embodiment.

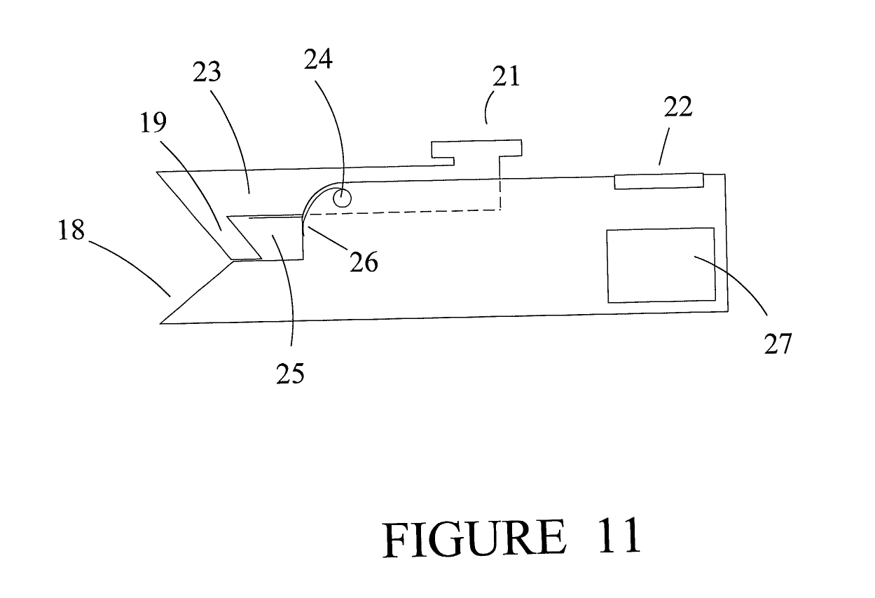

FIG. 11 illustrates an alternative embodiment, wherein connector 10 does not have an outer casing as in the main embodiment, but rather takes the form of a non-enclosed “clip”. Other parts, and other operating steps, are the same as in the main embodiment.

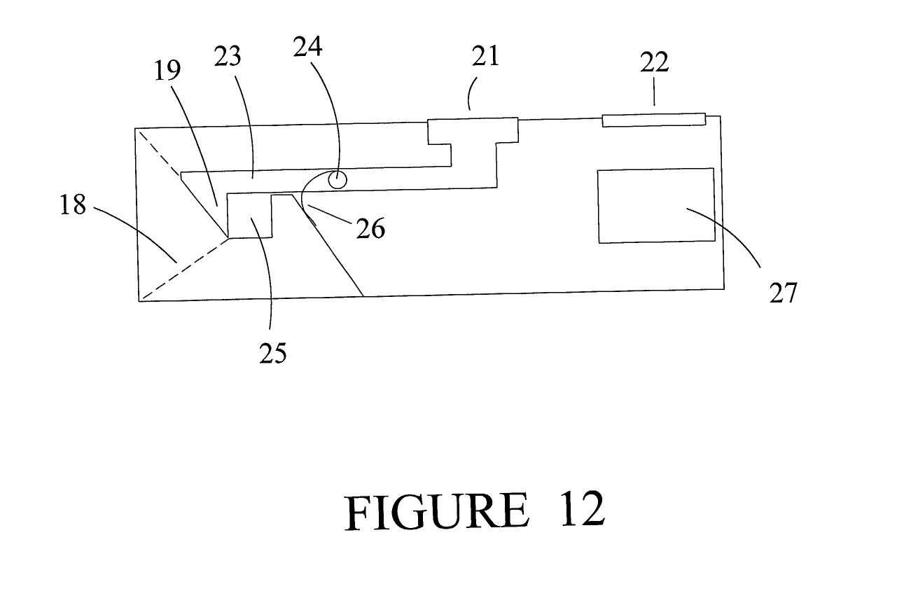

FIG. 12 illustrates an alternative embodiment, wherein the back (anchor bar-retaining) surface of latch plate 19 has a substantially non-beveled shape, rather than a beveled shape as in the main embodiment. Other parts, and other operating steps, are the same as in the main embodiment.

While the above descriptions contain many specificities, these shall not be construed as limitations on the scope of the invention, but rather as exemplifications of embodiments thereof. Many other variations are possible. Examples of just a few of the possible variations follow:

The length of the external casing of the connector—from the anchor end to the child seat end—and thus of course the length of the connector itself, can be different than that shown in the main embodiment.

The latch plate shape and structure can be different than that of the main embodiment, and FIG. 12 illustrates just one example of such an alternative latch plate structure.

The anchor and child seat release buttons can be located differently on the surface of the connector.

The docking guide surface can be arcuate—that is, have an inwardly curved nature, rather than angularly beveled as in the main embodiment.

The pivot point can be located at a different point along the length of the latch arm.

Various methods can be employed to spring-bias the latch arm, and thus the latch plate, to a closed position.

Different methods of blocking the latch arm from pivoting, and thus locking the latch plate in a downward and locked position, can be employed. A “slide lock”, in which a blocking element slides into position to block the pivoting of the latch arms, constitutes just one example of such an alternate method.

The use of a “black box” to illustrate the child seat latch serves to indicate that any one of a number of different, available latch mechanisms can be employed at the child seat end of the connector. These various latch mechanisms are well known in the prior art.

I claim:

1. A device for connecting a child safety seat to a vehicle anchor bar, comprising:
(a) a first end and a second end, and
(b) latch means, located at said first end, for capturing and retaining said anchor bar within said device, and
(c) connecting means, located at said second end, for attaching said device to said child safety seat, whereby said child safety seat is securely fastened to said anchor bar, and thus securely fixed to said vehicle.
